(19) United States
(12) Patent Application Publication
(10) Pub. No.: US 2002/0166776 A1
(43) Pub. Date: Nov. 14, 2002

(54) Electrochemical gas sensor

(76) Inventors: Axel Fikus, Gaegelow (DE); Bernd Lindner, Ratekau (DE)

Correspondence Address: HELLER EHRMAN WHITE & MCAULIFFE LLP, 1666 K STREET,NW, SUITE 300, WASHINGTON, DC, 20006, US

(21) Appl. No.: 09/852,296

(22) Filed: May 10, 2001

(51) Int. Cl. G01N 27/404

(52) U.S. Cl. 205/782; 205/783; 204/415

(57) ABSTRACT

The invention relates to an electrochemical gas sensor with a working electrode, which is designed as a thin-film electrode, and at least one counterelectrode, which are in electrical contact via an electrolyte. The electrochemical gas sensor is characterized in that the electrolyte is alkaline and preferably comprises a solution of a salt of a weak acid. The electrochemical gas sensor according to the invention may preferably be used to determine the oxygen concentration in a gas mixture.

The invention relates to an electrochemical gas sensor having a working electrode, which is designed as a thin-film electrode, and at least one counterelectrode, which are in electrical contact via an electrolyte. The sensor has an increased level of sensitivity compared to conventional sensors.

Electrochemical gas sensors have long been known. In principle, an electrochemical gas sensor is a simple electrolyte cell, comprising two or more electrodes which are connected to one another in an electrically conductive manner via an electrolyte liquid. The gas to be measured is fed to the working electrode, for example via a semi-permeable membrane, where it enters into an electrochemical reaction. A measurable electrical signal, which preferably exhibits a linear relationship with the concentration of the specific gas which enters into the chemical reaction, is generated.

Known electrochemical gas sensors for determining the oxygen concentration in a gas mixture usually include a metal grid as working electrode, which is mechanically clamped to a gas-permeable membrane. A corresponding gas sensor is described, for example, in U.S. Pat. No. 5,336,390. As an alternative, the working electrode is designed as a gas diffusion electrode, which comprises a mixture of catalyst and organic binder which are sintered with a gas-permeable membrane under pressure and elevated temperature, as described, for example, in the German laid-open specification DE-A 198 45 318. In a third embodiment, the working electrode can be applied to a gas-permeable membrane by deposition of a metal layer using thick-film technology.

These known oxygen sensors have the drawback of requiring a relatively high manufacturing outlay in order, for example, to suppress as far as possible deviations in the manufacturing tolerances. Furthermore, the sensitivity of these sensors is unsatisfactory for some applications and it would be desirable to shorten the response times of these known oxygen sensors.

In addition to the abovementioned known electrochemical gas sensors, the working electrode of which comprises a metal grid or a relatively thick metal layer, electrochemical gas sensors with a working electrode formed as a thin-film electrode are also known. By way of example, DE-A 197 45 486 discloses an electrochemical measurement cell for detecting arsane and phosphane, in which the working electrode is designed as a thin-film electrode and in which the electrolyte comprises sulphuric acid with an electrolyte addition of silver sulphate. The intention is to improve the cross-sensitivity with respect to other gases.

DE-A 198 59 198 describes an electrochemical gas sensor for the selective determination of the nitrogen monoxide concentration in a gas mixture. The working electrode is obtained by thin-film deposition of at least one metal and a nonmetal on a substrate.

The intention is to reduce the cross-sensitivity with respect to other polluting gases, in particular with respect to carbon monoxide. Possible electrolytes mentioned, in addition to sulphuric acid and phosphoric acid, include, in general, alkaline solutions, although in the example 35% strength sulphuric acid is used as electrolyte.

With regard to alkaline electrolytes, the widely held opinion has been that thin-film electrodes in particular with sputtered metal layers are mechanically unstable in solutions with a high pH, on account of the creep capacity of concentrated lyes, and therefore alkaline solutions are unsuitable as electrolytes for gas sensors with working electrodes of this type.

Therefore, it is an object of the present invention to provide a gas sensor which does not have the drawbacks of the gas sensors known in the prior art. In particular, it is to be possible to produce the gas sensor with a low manufacturing outlay, and this sensor is to have a high sensitivity and the shortest possible response time.

Surprisingly, it has been found that despite the existing prejudices a working electrode which is designed as a thin-film electrode is stable in a strongly alkaline electrolyte solution, and that as a result it is possible to provide an electrochemical gas sensor for determining the oxygen concentration in a gas mixture which overcomes the above-mentioned drawbacks.

The present invention therefore relates to an electrochemical gas sensor having a working electrode, which is designed as a thin-film electrode, and at least one counterelectrode, which are in electrical contact via an electrolyte, characterized in that the electrolyte is alkaline.

The structure of the electrochemical gas sensor may be designed as a two-electrode system or as a three-electrode system, as described, for example, in U.S. Pat. No. 5,336,390. In this case, in addition to the working electrode, the gas sensor according to the invention comprises a counterelectrode (two-electrode system) or a counterelectrode and a reference electrode (three-electrode system). Multielectrode systems, such as for example four-electrode systems, are also possible, but these are not based on any novel technical measurement concept compared to the three-electrode systems.

Conventional electrodes from the prior art can be used as counterelectrode or as counterelectrode and reference electrode, but it is also possible for a thin-film electrode to be used as counterelectrode or reference electrode. The counterelectrode used is preferably a porous lead body, as described, for example, in U.S. Pat. No. 5,336,390. This porous lead body is impregnated with electrolyte during production of the sensor.

The pH of the alkaline electrolyte preferably lies in a range from 8-14, particularly preferably from 12-14. With a strongly alkaline electrolyte of this nature, the person skilled in the art would have reckoned with the stability of the thin-film electrode being reduced. Surprisingly, however, it has now been found that corresponding stability problems do not occur despite the high pH of the electrolyte.

The stability of the thin-film electrode in the gas sensor of the present invention can be influenced by the concentration of the base in the electrolyte. With decreasing concentration of the base the stability of the thin-film electrode increases, the conductance of the electrolyte, however, decreases. If desired the skilled person using these parameters can easily determine an optimum for stability and conductance. Preferably the concentration of the base may be in the range of from 0.01 to 0.02 mol/l.

The electrolyte is preferably an aqueous solution.

Furthermore, it has also surprisingly been found, that the stability of the thin-film electrode can be further improved by the presence of a salt of a weak acid.

In principle, all known salts of weak acids which exhibit good solubility in water and do not have an adverse affect on the sensor properties are suitable as the salt of a weak acid. Water-soluble phosphates, water-soluble hydrogen phosphates, water-soluble hydrogen carbonates, water-soluble carbonates and water-soluble salts of weak organic acids, like water-soluble acetates, water-soluble phthalates, water-soluble oxalates, water-soluble maleates, water-soluble fumarates, water-soluble tartrates, water-soluble citrates and water-soluble succinates are preferred. These compounds are preferably used in the form of their alkali metal salts, and particularly preferably in the form of their sodium or potassium salts. Potassium acetate has proven particularly advantageous. It is also possible to use mixtures of two or more salts of weak acids.

The high pH of the electrolyte is preferably established using a strong base. In principle, all strong bases which are readily soluble in water and which do not have an adverse affect on the sensor properties are suitable for this purpose. Water-soluble hydroxides, and in particular alkali metal hydroxides, such as for example sodium hydroxide and potassium hydroxide, have proven particularly suitable.

The concentrations of the salt of a weak acid and of the strong base in the electrolyte can be selected appropriately for the desired properties of the electrochemical gas sensor by the person skilled in the art, but should be such that the pH of the electrolyte preferably lies in a range from 12-14, since it is in this way possible to ensure a high electrolytic conductivity. The concentration of the salt of a weak acid in the electrolyte may, for example, lie in the range from 10 to 1000 mg/ml, preferably from 100 to 700 mg/ml.

In a particularly preferred embodiment of the electrochemical gas sensor according to the invention, this sensor contains an electrolyte which comprises an aqueous solution of potassium acetate and potassium hydroxide, and the concentration of potassium acetate and potassium hydroxide are selected in such a way that the pH of the electrolyte lies in the range from 12-14. The electrolyte preferably comprises a solution of approximately 500 mg/ml of potassium acetate and approximately 1 mg/ml of potassium hydroxide in water.

The thin-film electrode of the electrochemical gas sensor according to the invention preferably comprises an active layer on a substrate, the active layer being obtainable by thin-film deposition the substrate. The active layer of the thin-film electrode may in principle comprise any desired precious metal or alloy of a precious metal, such as for example gold, platinum, silver or palladium. An active layer of gold is preferably used for determining the oxygen concentration in a gas mixture.

Processes for producing thin-film electrodes are known in the prior art. Reference is made in particular to DE-A 198 59 198, in which the thin-film deposition of metal components on a substrate by means of commercially available equipment, such as for example the PLS 500 coating installation produced by Balzer, with three magnetron sputtering sources and one high-frequency sputter etcher, is extensively described. The content of this disclosure is incorporated by reference in the present description.

The thin-film electrode of the electrochemical gas sensor according to the invention is preferably a sputtered electrode, the active layer being sputtered onto a substrate for example by means of the smallscale sputtering installation “Sputter Coater S150 B” produced by Edwards. In this process, it is possible, for example, for a laminate membrane produced by GORE to be used as substrate and for a gold target to be used. The laminate membrane may be coated, for example, for about three minutes.

Preferably, the coating is carried out in such a way that the active layer on the substrate is of a suitable thickness. The layer thickness will generally not exceed 1 μm, layer thicknesses of 200-600 nm being preferred. The appropriate layer thickness can easily be determined by the person skilled in the art for a specific arrangement using simple, routine tests.

Any known substrate can be used as the substrate for the active electrode of the electrochemical gas sensor according to the invention. For example, it is possible to use liquid-pervious substrates, such as a porous ceramic body or a porous glass substrate. If a liquid-pervious substrate of this type is used, the substrate is electrolyte-pervious and serves as an electrolyte reservoir. In this case, in the gas sensor according to the invention the active layer of the working electrode faces outwards. To delimit the cell space, a membrane which is impervious to liquids is applied to the active layer.

Alternatively, it is also possible to use a substrate which is impervious to liquids, for example a liquid-impervious, gas-permeable membrane. The substrate then serves as a support for the active layer, as a diffusion membrane for the gas and, furthermore, closes off the electrolyte space with respect to the outside. In this embodiment of the gas sensor according to the invention, the active layer faces inwards. Suitable membranes, such as for example organic films, which can serve as liquid-impervious, gas-permeable membranes, are known in the prior art.

Preferably, according to the invention, the thin-film electrode comprises an active layer which is applied to a liquid-impervious, gas-permeable membrane as substrate.

The electrochemical gas sensor according to the invention can be used in any desired processes and apparatus of the prior art, for example to determine the oxygen concentration in a gas mixture. The concentration of oxygen which can be determined using the gas sensor according to the invention is not subject to any particular restrictions. However, a particular advantage of the gas sensor according to the invention is its particular sensitivity, which is increased up to twenty times compared to conventionally produced sensors. Accordingly, the gas sensor according to the invention can also preferentially be used at very low concentrations of oxygen, for example at concentrations of approximately 100-1000 ppm.

In a preferred embodiment, the electrochemical gas sensor according to the invention has a short response time.

A further advantage of the electrochemical gas sensor according to the invention consists in the low manufacturing outlay compared to conventionally produced oxygen sensors, since the significant elements of the sensor (gas-permeable membrane and working electrode) are joined to one another in one working step. This shortens the manufacturing time and means that deviations in the manufacturing tolerances on account of complete automation do not occur or at least occur to a lesser extent. As a result, not only can the gas sensor according to the invention be produced at lower cost, but also the measurement accuracy is additionally increased.

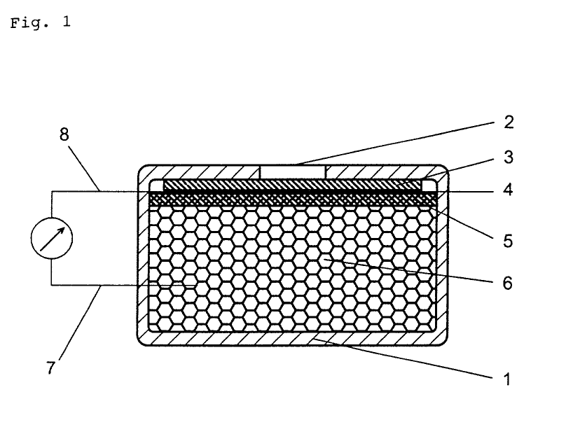

FIG. 1 shows an electrochemical gas sensor according to the invention.

The following example explains the invention, without restricting it to this example.

### EXAMPLE

A small-scale sputtering installation “Sputter Coater S150 B”, produced by Edwards, with a gold target was used to produce a working electrode. This coating installation was used to coat a laminate membrane produced by GORE as the substrate. The coating time was 3 minutes.

A working electrode was stamped out of the laminate membrane coated with gold and was fitted into an oxygen sensor as illustrated in FIG. 1, to which reference is made below.

The working electrode, comprising laminate membrane 3 and sputter coating 4, with outgoing electrical line 8, and the counterelectrode 6 with outgoing electrical line 7, are accommodated in a housing 1. The gas or gas mixture to be analysed was passed to the diffusion membrane 3 via the diffusion opening 2. In the embodiment shown, the counterelectrode comprises a porous lead body which is impregnated with the electrolyte (cf. for example U.S. Pat. No. 5,336,390). Electrolytic contact with the working electrode takes place via a separation nonwoven 5, which has likewise been impregnated with the electrolyte solution. The electrolyte comprises an aqueous solution of 5 molar potassium acetate and 0.0166 molar potassium hydroxide.

1. An electrochemical gas sensor comprising a working electrode, which is designed as a thin-film electrode, and at least one counterelectrode, which are in electrical contact via an electrolyte, wherein the electrolyte is alkaline.

2. The electrochemical gas sensor of claim 1, wherein the electrolyte comprises a solution of a salt of a weak acid.

3. The electrochemical gas sensor of claim 2, wherein the electrolyte has a pH in the range of from 12-14.

4. The electrochemical gas sensor of claim 2, wherein the salt of a weak acid is selected from the group consisting of water-soluble salts of weak organic acids, water-soluble phosphates, water-soluble hydrogen phosphates, water-soluble hydrogen carbonates, and water-soluble carbonates.

5. The electrochemical gas sensor of claim 1, wherein the electrolyte comprises the solution of a strong base, preferable of a water-soluble hydroxide.

6. The electrochemical gas sensor of claim 5, wherein the electrolyte comprises an aqueous solution of an alkali metal acetate and an alkali metal hydroxide.

7. The electrochemical gas sensor of claim 1, wherein the working electrode comprises an active layer on a substrate, the active layer being obtainable by thin-film deposition on the substrate.

8. The electrochemical gas sensor according to claim 7, wherein the working electrode is designed as a sputtered electrode.

9. The electrochemical gas sensor according to claim 8, wherein the active layer consists of a precious metal or an alloy of a precious metal, preferably of gold.

10. The electrochemical gas sensor according to claim 9, wherein the substrate is a liquid-impervious, gas-permeable membrane.

11. The electrochemical gas sensor of claim 6, herein said electrolyte comprises potassium acetate and potassium hydroxide.

12. A process for producing an electrochemical gas sensor, comprising producing a working electrode by thin-film technology with at least one counterelectrode and an electrolyte to form said electrochemical gas sensor, wherein said electrolyte is alkaline.

13. The process of claim 12, wherein said electrolyte comprises a solution of a salt of a weak acid.

14. A process for determining the oxygen concentration in a gas mixture comprising contacting said gas mixture with an electrochemical gas sensor comprising a working electrode, which is designed as a thin-film electrode, and at least one counterelectrode, which are in electrical contact via an electrolyte, wherein the electrolyte is alkaline and measuring said oxygen in said mixture.
